(19) United States
(12) Patent Application Publication
(10) Pub. No.: US 2019/0315112 A1
(43) Pub. Date: Oct. 17, 2019

(54) PROCESS AND APPARATUS FOR PRODUCING MULTILAYER METAL STRIP PACKS

(71) Applicant: Muhr und Bender KG, Attendom (DE)

(72) Inventors: Hartmut Saljé, Erfurt (DE); Benjamin Dönges, Dortmund (DE); Michael Schebitz, Attendorn (DE); Andreas Rinsdorf, Freudenberg (DE); Peter Janssen, Ratingen (DE); Thomas Muhr, Attendorn (DE)

(21) Appl. No.: 16/361,293

(22) Filed: Mar. 22, 2019

(30) Foreign Application Priority Data
Apr. 16, 2018 (DE) 10 2018 109 008.0

(51) Int. Cl. B32B 37/20; B21B 1/22; B32B 15/01; B32B 38/00; B32B 37/12

(52) U.S. Cl. CPC B32B 37/20; B21B 1/22; B32B 15/01; B32B 2255/26; B32B 37/12; B32B 2255/06; B32B 38/0004

(57) ABSTRACT

Producing multilayer sheet metal strip stacks comprises feeding a metallic strip material having an upper side and a lower side by a feeding arrangement, longitudinally dividing of the fed strip material in a longitudinal direction of the strip material into a plurality of sheet metal strips in a continuous process by a strip dividing arrangement, and continuously superimposing of at least some of the sheet metal strips to form a sheet metal strip pack by a guiding arrangement.

### CROSS-REFERENCE TO RELATED APPLICATIONS

This application claims priority to German Application No. DE 10 2018 109 008.0, filed on Apr. 16, 2018, which application is hereby incorporated herein by reference in its entirety.

### BACKGROUND

Electric motors have a rotor and a stator. The stator is arranged in a rotationally fixed and stationary position and builds up a first magnetic field by means of permanent magnets or coils. The rotor is rotatably mounted relative to the stator and builds up a second magnetic field by means of permanent magnets or coils. To generate a drive torque, the two magnetic fields are brought into magnetic interaction by controlled reversal of the polarity of the magnetic fields. One of the magnetic fields is usually generated by a coil through which alternating current flows in order to implement the polarity reversal. To conduct the field lines of both magnetic fields and reduce the magnetic resistance, the permanent magnets are inserted into ferromagnetic cores, and/or the coils are arranged around ferromagnetic cores. The cores are mostly designed as cylindrical cores. In DIN EN 61021, for example, a large number of types and type series for cores are standardized. In addition, special shapes are also used. With increasing frequency and amplitude of the alternating current in the coils forming the magnetic field, eddy currents are induced in the cores in the direction of the cylinder axis, which lead to magnetic losses. In order to minimize this effect, multilayer sheet packages can be used as cores. The thinner the individual layers, the lower the eddy current losses. The individual metal strips can be electrically separated from each other by introducing an insulation layer and then joined together to form a package. The insulation layer can be a suitable foil or, for example, formed by an adhesive that is also used for joining. The metal strips are cut out of strip material before they are wound with a coil in the case of a stator stack, or joined with a shaft in the case of a rotor stack. Depending on the machine type, the sheet metal packs of the rotor are equipped with permanent magnets, short-circuit cages or coils.

From JP 2005 297393 A, a process for producing multilayer sheet metal strip packs is known. In each case, ferromagnetic strip material wound on two drums arranged one above the other is unwound and placed one above the other by a conveyor roller. An adhesive insulation layer is applied between the two material strips in front of, i.e., upstream of, the conveyor roller. This is done either by applying adhesive in a roller-formed coater or by inserting an adhesive-bearing film between the two metal strips. The joint is then cured under pressure and hardened under heat exposure. The two-layer metal strip formed in this way can then be wound onto a drum and the process repeated several times. Finally, the multi-layer strips are fed to a press and blanks are punched in the desired shape.

DE 31 10 339 C2 discloses another process for producing multi-layer sheet metal strip packs. A thin electrical steel strip that is coated on both sides with pre-hardened duroplastic adhesive is unwound from a drum. It is then fed to a punching press via a straightening and feed device. In the punching press, lamellas are cut out of the sheet metal strip and stacked in a magazine to form a stack of sheets. Subsequently, the stack of sheets is transported via a conveyor belt to a curing zone and then to a cooling zone where it is glued under pressure.

In car body construction, multi-layer sheet metal strip packs are used among other things as body sound-absorbing composite sheets, as proposed for example in WO 2016/058740 A1 and EP 1 569 793 B1.

In WO 2016/012182 A1 a process for producing of composite sheets is known in which two outer metallic layers are unwound from two separate rolls and a plastic layer from a third roll. The three layers are continuously combined in a first laminating unit through a first laminating gap to form a strip stack. Subsequently, the sheet metal strip pack is first fed into a first heating zone and into a second laminating unit with a second laminating gap. Finally, the laminated strip pack is transported through a cooling zone.

The previously described manufacturing processes for multi-layer sheet metal strip stacks show either high throughput times or high plant complexity and are therefore uneconomical.

### SUMMARY

Disclosed herein is a process and an apparatus for producing multi-layer sheet metal strip packs, in particular for use in automotive applications. Main applications are multilayer sheet metal strip packs as semi-finished products for the cores of rotors and stators in electric motors and also as semi-finished products for car body components. The process and apparatus lead to low production costs.

A process for producing multilayer sheet metal strip packs comprises feeding a metallic strip material, which has an upper side and a lower side, by means of a feeding arrangement; longitudinally dividing of the strip material in a longitudinal direction of the strip material into a plurality of metal strips in a continuous process by means of a strip dividing arrangement, and continuously superimposing of at least some of the metal strips to form a metal strip pack by means of a guiding arrangement.

An advantage of the process is that the strip stacks are produced in a continuous process, strip material can be supplied in standard sizes and changeover times can be reduced.

In a possible embodiment of the process, the width of the supplied, i.e., fed strip material is maximum 4500 mm (millimeters), e.g., maximum 2500 mm, e.g., maximum 2000 mm, with the term maximum meaning less than or equal to the respectively mentioned width. The width is defined by the distance between the sides of the strip material extending in the transport direction. The thickness of the fed strip material shall preferably be greater than 0.04 mm, e.g., greater than 0.05 mm, and/or e.g., preferably less than 3 mm, in particular less than 2 mm. The thickness is oriented perpendicular to the width. The strip material can have a uniform or variable thickness in the longitudinal direction. The strip material can be fed continuously, for example by uncoiling coils, or sequentially as strip material of predefined length. The fed strip material can be a multi-layer strip stack, in particular a strip stack produced by a process as described herein in order to realize a high number of layers.

If the sheet metal strip packs are used as semi-finished products for producing cores for electric motors, the strip material may be made of a ferromagnetic metal, in particular an electrical strip.

According to an embodiment, the strip material can be fed uncoated. Uncoated is to be understood to include a strip material that has a precoating, for example for corrosion protection or passivation, which does not serve to insulate or join the metal strips. In a further embodiment, strip material can be fed into the process, which has a pre-coating that serves to insulate or join the metal strips.

In a possible embodiment, a plastic coating can be applied to at least one of the top and bottom sides of the fed strip material or sheet metal strip by means of a coating arrangement. The coating arrangement is configured to apply a coating to the strip material; it can also be referred to as coating device. The plastic coating can be applied over the entire surface. Alternatively, the application of the coating can also be carried out in a punctiform manner. The coating can extend completely over the width of the strip material or sheet strips. Alternatively, areas can be kept free of the coating material when applying the plastic coating. In addition to roll coating, other surface coating processes such as spray coating and powder coating are also conceivable. A punctiform application of the coating material can be realized by means of appropriate spray heads. The plastic coating can be applied over part of the width of the fed strip material or sheet strips or over the entire width of the fed strip material or sheet strips.

The plastic coating can include an adhesive, bonding varnish or insulation varnish. The plastic coating thus achieves an electrical separation of the sheet layers and/or the sheet layers are joined together by the plastic coating. Alternatively, the plastic coating can be a viscoelastic polymer. Due to the damping properties of the visco-elastic polymer, this plastic coating is used in particular in vibration-damped sheet metal packages for car body components.

The plastic coating can be applied to the strip material before the strip material is fed. Alternatively, the plastic coating can be applied to the strip material after feeding and before slitting into several sheet strips. If the coating material is applied to the metal strips, it can be applied after slitting and before rolling.

The longitudinal dividing of the fed strip material in a longitudinal direction of the fed strip material into several sheet strips is carried out via a strip dividing arrangement. The strip dividing arrangement can depict any separating manufacturing process, in particular laser beam, plasma or water jet cutting, cut-off grinding, punching or shear cutting. The strip dividing arrangement can also be referred to as strip dividing device or strip cutting arrangement. The metal strips produced by longitudinally dividing the fed strip material can have the same width among each other in at least one partial number. The metal strips remain connected to the fed strip material in the plane perpendicular to the transport direction of the strip material in which the strip dividing arrangement is arranged, so that the longitudinal cutting takes place continuously.

The continuous superimposing of at least a partial number of the metal strips to form a pack of metal strips is effected by means of a guiding arrangement. The guiding arrangement, which can also be referred to as guiding device, can comprise a plurality of deflection rollers and guide rollers, in particular for lateral guidance of the metal strips, in order to enable the metal strips to be guided, i.e., superimposed transversely to the transport direction. The metal strips superimposed on one another form a pack of metal strips, that can also be referred to as metal strip stack. It is possible that the metal strips that have been divided from one strip material are combined to form several separate sheet metal strip packs. For example, a first group of metal strips can be superimposed on one another to form a first metal strip pack, and a second group of metal strips can be superimposed on one another to form a second metal strip pack. In particular, metal strips of the same width can be combined to form a sheet metal strip pack.

According to an embodiment, the sheet metal strip packs can be rolled by means of a rolling arrangement. The rolling arrangement, which can also be referred to as rolling device, is configured to press the superimposed metal strips together. The rolling force during rolling can be set such that air inclusions in the plastic coating are pressed out and/or such that the plastic coating is evenly distributed. It is also possible that the rolling force is set such that the sheet layers undergo plastic deformation. Rolling can take place under the supply of heat in order to initiate curing of the plastic coating, especially in the case of thermosetting plastics. The heat can be supplied via a furnace in which the rollers are arranged. Alternatively, the rolls can be heated directly. The rolling can then be followed by a cooling section. In particular with cold-curing plastic coatings, heat input can be dispensed with.

In a possible embodiment, the metal strip packs can be coiled-up to spools, i.e., coils by means of a coiling arrangement. The coils can be marketed as semi-finished products or transferred to a downstream process step. Alternatively, the sheet metal strip packs can be contoured to form contoured metal packs by means of a contouring arrangement. The contouring arrangement, which can also be referred to as contouring device, is thus configured to produce from the metal strip pack individual metal packs with a defined contour. The contouring can be effected in particular by shear cutting, for example punching or fine blanking. Fine blanking, for example, enables the economical production of components with high dimensional accuracy requirements. However, any other cutting process is also conceivable, such as normal stamping or laser beam cutting. The sheet packages can, for example, be produced in the form of non-segmented stator or rotor cores, in particular as 360° rounds, as well as segmented stator or rotor cores. If the individual sheet layers of the sheet packs are not connected to each other in a material-locking manner, the contouring arrangement can have a magazine for receiving the sheet packs, in which the sheet packs can be joined to form a unit.

In a further possible embodiment, the longitudinal cutting of the fed strip material into a plurality of sheet metal strips can be effected by at least one separating unit which is arranged in a separating plane perpendicular to the transport direction, and the continuous superimposing of at least a partial number of the sheet metal strips can be effected in a joining plane perpendicular to the transport direction. A percentage deviation between a distance traveled by the individual sheet metal strips between the parting plane, which has the greatest distance to the joining plane, and the joining plane, can be less than 25%, e.g., less than 15%, in particular less than 10%. This allows the material waste to be reduced when feeding new strip material, for example from a new drum.

An apparatus for producing multi-layered metal strip packs includes a feeding arrangement for the feeding of a metallic strip material, a strip dividing arrangement for dividing the strip material into a plurality of metal strips in a longitudinal direction of the strip material, and a guiding arrangement for continuously guiding, i.e., superimposing at least some of the plurality of metal strips on one another to form a pack of metal strips.

The features of the process described above can be applied analogously to the proposed apparatus. The apparatus therefore has the same advantages as the process described above and also allows a space-saving design.

The apparatus may include, in a possible embodiment, a coating arrangement for applying a plastic coating to at least one of the top and bottom sides of the strip material or the metal strips derived therefrom. The apparatus may further include a rolling arrangement for rolling the sheet metal strip packs. In particular, the rolling arrangement may be equipped with an additional heat supply, the heat being supplied by a furnace or by heating the rolls of the rolling device.

According to a possible embodiment, the apparatus can comprise a contouring arrangement for separating contoured packs from the strip packs or a winding arrangement for winding the strip packs to a coil.

### BRIEF SUMMARY OF THE DRAWINGS

Exemplary embodiments are described below according to the drawing figures, which show:

FIG. 1 schematically illustrates an example apparatus for producing multilayer sheet metal strip stacks in a first embodiment;

FIG. 2 schematically illustrates a contouring arrangement for the apparatus according to FIG. 1;

FIG. 3 schematically illustrates a coiling arrangement for the apparatus according to FIG. 1;

FIG. 4 schematically illustrates an example apparatus for producing multilayer sheet metal strip stacks in a second embodiment;

FIG. 5 illustrates a process for producing multilayer sheet metal strip stacks in a first embodiment;

FIG. 6 illustrates a process for producing multilayer sheet metal strip stacks in a second embodiment;

FIG. 7 illustrates a process for producing multilayer sheet metal strip stacks in a third embodiment;

FIG. 8 illustrates a process for producing multilayer sheet metal strip stacks in a fourth embodiment;

FIG. 9 illustrates a process for producing multilayer sheet metal strip stacks in a fifth embodiment;

FIG. 10 illustrates a process for producing multilayer sheet metal strip stacks in a sixth embodiment;

FIG. 11a illustrates a process for producing multilayer sheet metal strip stacks in a seventh embodiment;

FIG. 12 illustrates a process for producing multilayer sheet metal strip stacks in an eighth embodiment;

FIG. 13 illustrates a process for producing multilayer sheet metal strip stacks in a ninth embodiment;

FIG. 14 illustrates a process for producing multilayer sheet metal strip stacks in a tenth embodiment.

### DESCRIPTION

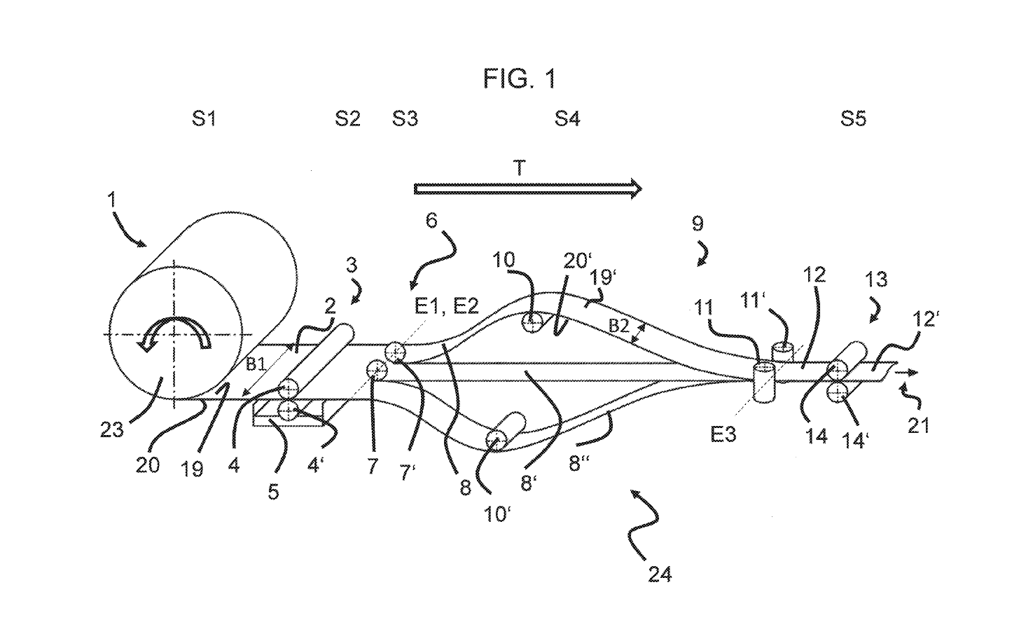

FIG. 1 shows a method and device, respectively, for producing multilayer sheet metal strip packs (12′) in a first embodiment.

In a first process step S1, a coiled and preferably non-coated strip material 2 is unwound from a drum 23 by means of a feeding arrangement 1 and fed, i.e., provided for being further processed. The strip material 2 comprises a top surface 19 and a bottom surface 20 and has a width B1 and a thickness D1 which is only schematically shown in the drawings, the width B1 extending between a first long side and a second long side of the strip material 2 and being oriented transversely to a transport direction T of the strip material 2. The width B1 can be, for example, 2500 mm, without being limited thereto. The thickness D1 of the strip material 2 is constant in transport direction T. The thickness D1 can alternatively be variable. The strip material 2 can be made of a ferromagnetic metal without being limited thereto.

Process step S1 is followed by process step S2, in which the strip material 2 is coated with a plastic coating in a coating arrangement 3. An insulating varnish is used as coating material for this purpose. It is also possible to use an adhesive, bonding varnish or visco-elastic polymer as coating material. In a roll coating process, the strip material 2 is fed through two vertically arranged coating rolls 4, 4′ for applying the coating material to the strip material. The lower coating roller 4′ is supplied by a material reservoir 5 as shown. The upper coating roller 4 is also supplied with the coating material by a material reservoir not shown in the figures. By rolling the coating rollers 4, 4′ onto the strip material 2, the strip material 2 is wetted with the coating material over the entire width B1. It is also possible that several coating rollers 4 arranged next to each other wet the top side 19 and/or the bottom side 20 of the strip material 2, with areas between the rollers being kept free of coating material. As an alternative to roll coating, any other surface coating such as spray coating, powder coating or point-like application of the coating material is also possible.

Process step S2 is followed by process step S3, in which the strip material 2 in a strip division arrangement 6 is divided into three sheet strips 8, 8′, 8″, without the number being limited thereto. For this purpose, two rotating cutting discs 7, 7′ cut the strip material 2 in the longitudinal direction, i.e., in the transport direction T of the strip material 2. Alternatively, the cutting can also be carried out by a laser or a water jet. The sheet metal strips 8, 8′, 8″ produced in this way have the same width B2 in this case. However, it is also possible that a partial number of the sheet metal strips 8 have different widths B2. The sheet metal strips 8, 8′, 8″ are further connected to the supplied strip material 2 in an imaginary plane E1, E2 extending transverse to the transport direction T and in which the cutting discs 7, 7′ are arranged. Thus, the longitudinal cutting takes place in a continuous process.

Process step S3 is followed by process step S4, in which the previously produced sheet metal strips 8, 8′, 8″ are continuously guided one above the other by means of a guiding arrangement 9. For this purpose, the two outer sheet metal strips 8, 8″ are guided over deflection rollers 10, 10′ and the middle sheet metal strip 8′ is positioned between them. The sheet metal strips 8, 8′, 8″ are brought together, i.e., superimposed on one another through the guide rollers 11, 11′, which are arranged in an imaginary plane E3 at right angles to the transport direction T. The result is a three-layer sheet metal strip package 12, wherein the three sheet metal strips 8, 8′, 8″ are electrically separated from each other by the previously applied coating of insulating lacquer. The distance traveled by the sheet metal strips 8′ and 8″ over the deflection rollers 10 and 10′ between the dividing planes E1 and E2 and the joining plane E3 is, in the embodiment shown, greater than the distance traveled by the central sheet metal strip 8, which is straightly guided in the transport direction T between the dividing planes E1 and E2 and the joining plane E3. It is also possible that the central sheet metal strip 8 is also guided over deflection rollers, so that the path of the central sheet metal strip 8 between the dividing planes E1 and E2, and the joining plane E3, is substantially identical with the path of the lateral sheet metal strips 8′ and 8″. The sheet metal strips 8 can alternatively have at least two different widths B2, so that it is also possible that the sheet metal strips 8, which have the same width B2, are guided one above the other in each case, and thus several sheet metal strip packs 12 are formed, which are taken up by several pairs of guide rollers 11, 11′.

Process step S4 is followed by process step S5, in which the sheet metal strip pack 12 is rolled by means of a rolling arrangement 13. For this purpose, the sheet metal strip pack 12 is guided by two vertically arranged rollers 14, 14′, which apply a defined force to the strip pack 12. The force is selected in the present embodiment such that the coating material is distributed evenly between the sheet metal strips 8, 8′, 8″ and/or air inclusions are pressed out. However, it is also possible that the force is selected to be so large that the sheet metal strips 8, 8′, 8″ undergo plastic deformation. The rollers 14, 14′ can also be heated. Due to the heat thus introduced into the sheet metal strip pack 12, the insulating varnish hardens on a subsequent cooling section 21 and connects the individual layers of the sheet metal strip pack 12′ in a material-locking manner. For cold-hardening coating materials, the addition of heat can be dispensed with.

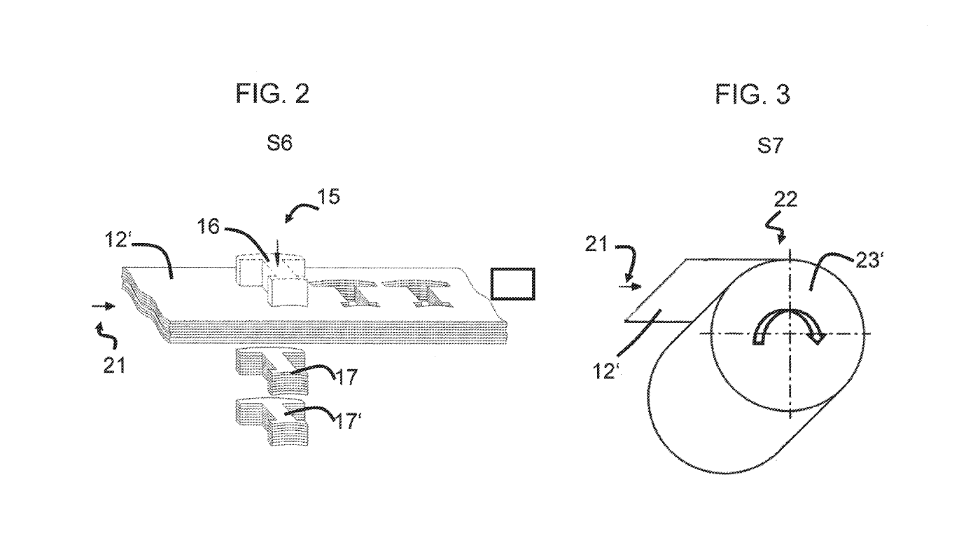

FIG. 2 shows a process step S6 downstream of process step S5 and an arrangement depicting this process step S6. From the sheet metal strip packs 12′, 15 sheet metal packs 17, 17′ in the form of segmented stator tooth cores for electric motors can be separated by means of a contouring arrangement, without being limited to this design. As an alternative, it is also possible that the contouring arrangement may be configured to produce sheet packages in the form of non-segmented stator or rotor cores, in particular as 360° circles, as well as segmented rotor cores. The individual sheet layers of the sheet packs 12′ are bonded to each other by the insulating lacquer. Of the contour arrangement 15, only the cutting tool 16 is shown to increase clarity. The contour arrangement 15 can also include a guiding plate with ring teeth, a cutting plate and an ejector in the case of fine blanking. It is also conceivable that a laser or water jet cutting instead of a fine blanking takes place in the contour arrangement 15. For components with lower dimensional accuracy requirements, a normal punch as contour arrangement 15 is conceivable.

FIG. 3 alternatively shows a process step S7 downstream of process step S5 and an arrangement depicting this process step S7. The rolled sheet metal strip packet 12′ is wound onto a drum 23′ to a spool, also referred to as a coil, by means of a winding arrangement 22. The coil can be sold as a semi-finished product or can be fed into a further processing operation, for example in a separate punching device. In particular, it is possible that the drum 23′ of the sheet metal strip packs 12′ serves as strip material for the process step S1 described above and runs through the process sequence shown in FIG. 1.

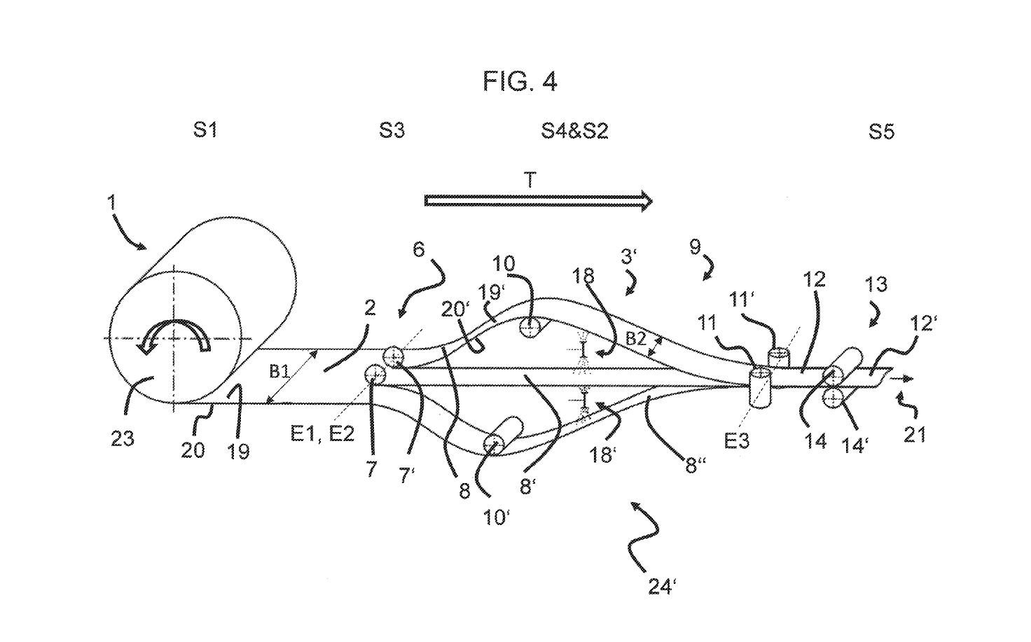

FIG. 4 shows a process and device 24′, respectively, in accordance with the invention for producing multilayer sheet metal strip packs (12′) in a second embodiment. The process, and/or device 24′, differs from the process, and/or device shown in FIG. 1 only in the arrangement of the process step of the coating and the position of the coating arrangement 3′, respectively. Coating by means of a coating arrangement 3′ of the upper side 19′ and lower side 20′ takes place within the guiding arrangement 9. For this purpose two painting units 18, 18′ are arranged between the sheet metal strips 8, 8′, 8″, which coat the sheet metal strips 8, 8′, 8″ on the surface in the spray painting process. In this process sequence, too, any other surface coating such as roll coating, powder coating or selective application of the coating material is possible. As described for the first embodiment, process step S5 can be followed by process step S6 described in FIG. 2 or process step S7 described in FIG. 3.

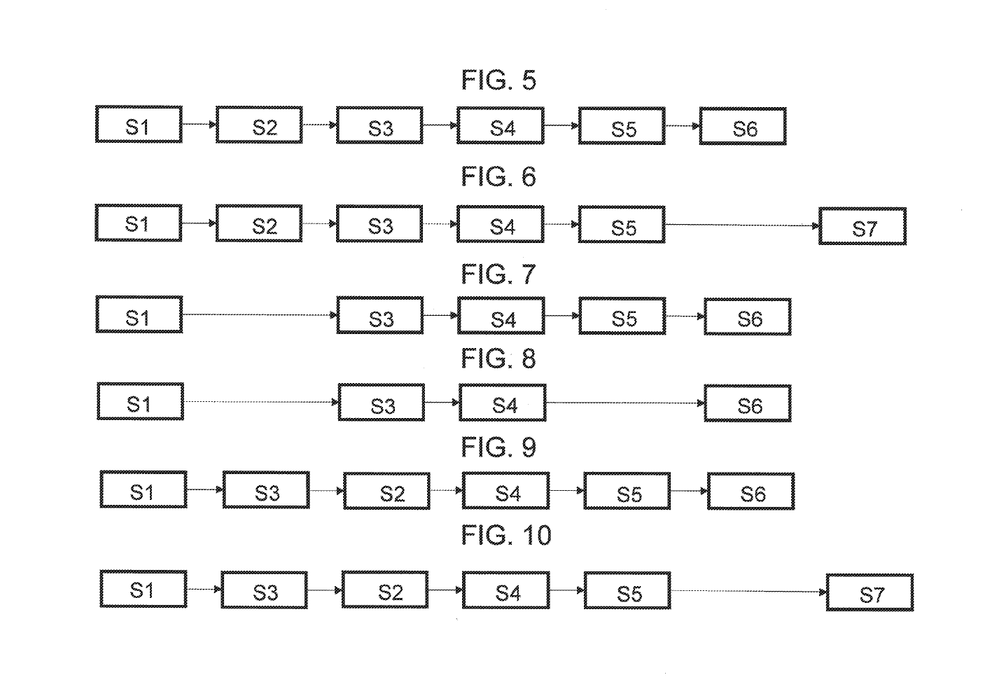

FIGS. 5 to 14 each describe possible embodiments on the basis of a respective flow chart. FIG. 5 illustrates the process by means of the flow chart, which results from the combination of the previously described FIGS. 1 and 2. FIG. 6 shows the flow chart of the process resulting from the combination of FIGS. 1 and 3. Reference is therefore made at this point to the previous description.

FIG. 7 shows a possible embodiment of the process, the process sequence of which differing from the process sequence in FIG. 6 in that process step S2 is omitted. In this respect, reference is made to the diagram in FIG. 5 for the joint process steps. Due to the omission of the coating in process step S2, the individual layers of the metal strip packs 12, 12′ are not separated from each other and lie directly on top of each other. In the rolling process S5, the heat supply can be dispensed with or the rolling process can be omitted according to the fourth possible process sequence shown in FIG. 8. In the subsequent process step S6, sheet stacks 17, 17′ in the form of segmented stator tooth cores are cut out of the sheet strip stacks 12′ in the contouring arrangement 15 without being restricted to this form. Because the individual layers of the sheet packs 17, 17′ are not connected, the contouring arrangement 15 comprises a magazine (not shown) for holding the loose sheet packs 17, 17′, in which a joining process can take place, for example by welding or riveting.

FIG. 9 shows another possible process sequence of a process for producing multilayer sheet metal strip stacks 12 on the basis of a flow diagram. The process sequence in FIG. 9 differs from the process sequence in FIG. 5 in that the sequence of process steps S2 and S3 is reversed. In this respect, reference is made to the explanations of FIG. 5 for the common features. By reversing process steps S2 and S3, the uncoated strip material 2 is first divided into several sheet metal strips 8, 8′, 8″. Subsequently, a plastic coating is applied to the surface of the metal strips 8, 8′, 8″ on an upper side 19′ and a lower side 20′ in a coating arrangement 3. Analogous to the description of the coating of the strip material 2 from FIG. 5, partial areas of the upper side 19′ and the lower side 20′ can also be kept free of coating material. As an alternative to roll coating, any other surface coating such as spray coating, powder coating or spot application is also conceivable.

FIG. 10 shows a possible process sequence of a process for producing multilayer sheet metal strip stacks 12 using a flow diagram, which differs from the process sequence in FIG. 9 in that process step S7 is omitted and process step S6 follows process step S5 directly.

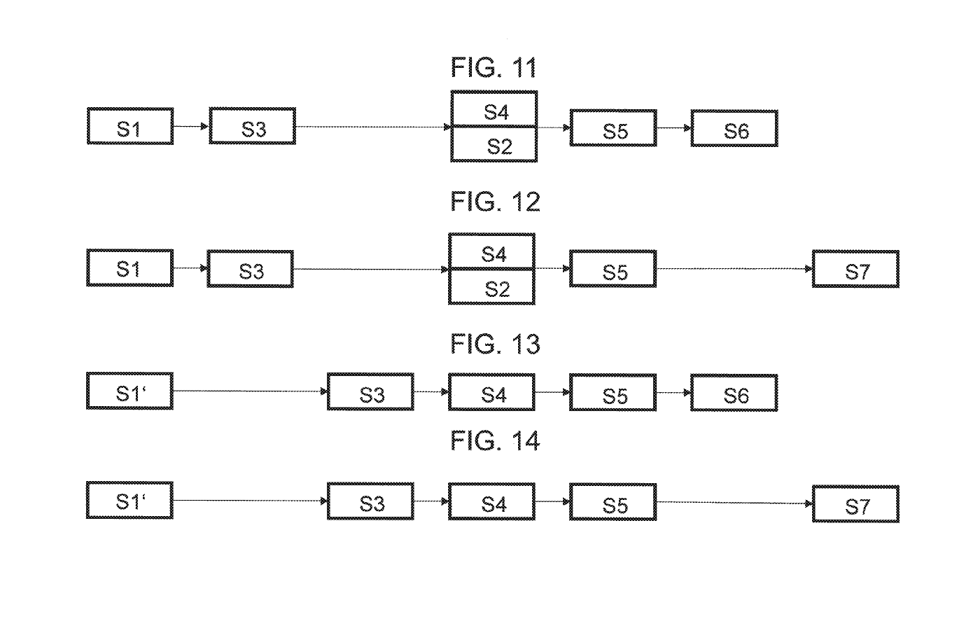

FIG. 11 shows a possible process sequence of a process for producing multilayer sheet metal strip packs 12 on the basis of a flow chart, which results from the combination of FIGS. 4 and 2. In this respect, reference is therefore made to the above description.

FIG. 12 shows a possible process sequence of a process for producing multilayer sheet metal strip packs 12 on the basis of a flow chart, which results from the combination of FIGS. 4 and 3. In this respect, reference is therefore made to the above description.

FIG. 13 shows another possible process sequence of a process for producing multilayer sheet metal strip stacks 12 on the basis of a flow diagram. The process sequence in FIG. 13 differs from the process sequence in FIG. 5 in that in step S1′ strip material 2, which has previously been coated, is unwound from a drum 23 and fed to the process and process step S2 is omitted. The previously applied coating is made of an insulating lacquer. However, it is also possible that an adhesive, baking varnish, insulation varnish or visco-elastic polymer is used. The process steps from S3 are identical with the process steps from FIG. 5, so that for corresponding features abbreviated reference is hereby made to the description of FIG. 5.

FIG. 14 shows another possible process sequence of a process for producing multilayer sheet metal strip stacks 12 on the basis of a flow diagram. The process sequence in FIG. 14 differs from the process sequence in FIG. 13 in that process step S6 is replaced by process step S7.

### REFERENCE CHARACTER LIST

1 feeding arrangement
2 strip material
3, 3′ coating arrangement
4, 4′ coating rollers
5, 5′ material reservoir
6 strip dividing arrangement
7, 7′ cutting discs
8, 8′, 8″ metal strips
9 guiding arrangement
10, 10′ deflection rollers
11, 11′ guide rollers
12, 12′ sheet metal strip packs
13 rolling arrangement
14, 14′ rolling rolls
15 contouring arrangement
16 cutting tool
17, 17′ sheet packages
18, 18′ lacquering unit
19, 19′ upper side
20, 20′ lower side
21 cooling section
22 rolling arrangement
23, 23′ drum
24, 24′ apparatus
B1 width of strip material
B2 width of sheet metal strip
D1 thickness of strip material
E1 dividing plane
E2 dividing plane
E3 joining plane
T transport direction

1.-15. (canceled)

16. A process for producing multilayer metal strip packs, comprising:
feeding a metallic strip material having an upper side and a lower side via a feeding arrangement;
continuously longitudinally dividing of the fed strip material in a longitudinal direction of the fed strip material into a plurality of metal strips by a strip dividing arrangement; and
continuously superimposing of at least some of the metal strips to form a metal strip pack by a guiding arrangement.

17. The process of claim 16, wherein the metal strip pack is coiled-up by a coiling arrangement to form a coil.

18. The process of claim 16, wherein the metal strip pack is contoured by a contouring arrangement to form a contoured metal pack.

19. The process of claim 16, wherein the metal strip pack is rolled by a rolling arrangement.

20. The process of claim 16, wherein a plastic coating is applied to at least one of the upper side and the lower side of the fed strip material or the metal strips by a coating arrangement.

21. The process of claim 20, wherein the plastic coating is applied to the strip material before or after feeding and before longitudinally dividing the strip material into a plurality of metal strips.

22. The process of claim 20, wherein the plastic coating is applied to the metal strips after longitudinally dividing and before rolling the metal strips.

23. The process of claim 20, wherein the plastic coating comprises at least one of an adhesive, bonding varnish, insulating varnish, or viscoelastic polymer.

24. The process of claim 16,
wherein the fed strip material has a thickness and a width;
wherein the width of the fed strip material is at most 4500 mm (millimeters); and
wherein the thickness of the fed strip material is greater than 0.04 mm and smaller than 3 mm.

25. The process of claim 16, wherein the fed strip material is a multi-layer metal strip pack.

26. The process of claim 16,
wherein the longitudinally dividing the fed strip material into a plurality of metal strips is effected by at least one dividing unit which is arranged in a dividing plane perpendicular to the transport direction;
wherein the continuously superimposing of the at least some of the metal strips is carried out in a joining plane substantially perpendicular to the transport direction; and
wherein a percentage deviation between a first path length that a first one of the metal strips travels between the dividing plane and the joining plane, and a second path length that a second one of the metal strips travels between the dividing plane and the joining plane, is less than 25%.

27. An apparatus for producing multilayer metal strip packs, comprising:
a feeding arrangement for feeding a metallic strip material;
a strip dividing arrangement for longitudinally dividing the strip material into a plurality of metal strips in a longitudinal direction of the fed strip material; and
a guiding arrangement configured to continuously superimpose at least some of the plurality of metal strips onto each other to form a metal strip pack.

28. The apparatus of claim 27, further comprising a coating arrangement for applying a plastic coating to at least one of the upper side and the lower side of the strip material or the metal strips.

29. The apparatus of claim 27, further comprising a rolling arrangement for rolling the metal strip pack, wherein the rolling arrangement comprises a heat supply.

30. The apparatus of claim 27, further comprising a contouring arrangement for separating out contoured metal packs from the metal strip pack.

31. The apparatus of claim 27, further comprising a coiling arrangement for coiling-up the metal strip pack to a coil.
